(19) United States
(12) Patent Application Publication
(10) Pub. No.: US 2014/0026558 A1
(43) Pub. Date: Jan. 30, 2014

(54) NOISE REDUCING POWER GENERATION DEVICE

(71) Applicant: Nathan Heuvel, Cardinal (CA)

(72) Inventor: Nathan Heuvel, Cardinal (CA)

(21) Appl. No.: 13/749,986

(22) Filed: Jan. 25, 2013

(30) Foreign Application Priority Data
Apr. 13, 2012 (CA) 2773932

(51) Int. Cl. F02B 63/04

(52) U.S. Cl. CPC F02B 63/04
USPC 60/597; 60/273

(57) ABSTRACT

The application of a Tesla turbine as an exhaust system that provides power to vehicle electrical systems or for charging an onboard battery that includes harnessing energy from the system exhausts. A Tesla turbine is implemented using the compressed gas/fluid to operate a generator. The generator is connected to appropriate systems (battery, electrical components, etc.) to provide power.

### BACKGROUND OF THE INVENTION

In the early 1900's Nicola Tesla invented a turbine that was subsequently patented in 1913 and became known as a boundary layer turbine. This type of turbine uses gas/liquids as means to turn the blades or discs in the turbine. The discs are stacked on top of each other with spacers between them.

It is also referred to as a bladeless turbine because it uses the boundary layer effect and not blades as in a conventional turbine. The principles of operation are well known.

Boundary layer turbines can work in reverse and can be used as a pump.

Boundary layer turbines have advantages versus more common blade based turbines. They are more efficient, they can accommodate much higher speeds, and more difficult to break then traditional turbine blades.

This invention makes use of such a turbine and relates to electrical charging and deriving power from the exhaust of a conventional gasoline powered engine.

The operation of vehicle combustion engines includes air intake, compression piston system, exhaust valves and an exhaust system. These engines run on gasoline or diesel fuels. Engines produce hot gases that are discharged through a catalytic converter and muffler. The catalytic converter removes harmful particulates from entering the atmosphere while the muffler provides a noise dampening function.

In addition, vehicles rely on power from the alternator to provide electricity to run the vehicle's power system. These systems offer power to on board systems such as ignition systems, windshield wipers etc.

In addition, vehicles rely on alternators to charge the battery. Batteries are used to provide power to all the electronic systems in a vehicle (ignition, dash functions, etc.). The present invention can replace the alternator and charge the battery in its place. Thus, the exhaust would be generating the power for the systems.

For hybrid vehicles (those that have both internal combustion engines and electric engines) this power generation could foe used to charge the engine batteries of the electric engine. Thus, when the car is powered by its gasoline engine, the exhaust can charge the on board battery of the electric engine. This provides the opportunity to increase operating distance by charging batteries while consuming fuel. In addition, the device provides the necessary noise reduction function performed by a traditional muffler.

With declining petroleum resources, the need for reducing emissions while maintaining society's reliance upon automobiles is essential. Using opportunities that can derive power from emissions provide balance to becoming carbon neutral.

### SUMMARY OF THE INVENTION

The present invention resides in a method for generating power from exhaust systems to replace current methods of power generation (alternator) to charge the battery of the vehicle. The method and system of the present invention is particularly adapted for automobiles. The invention will also reduce noise derived from the operation of an engine.

This invention would enable a hybrid vehicle to travel farther since the battery can be charged while running on the gasoline/diesel engine. Replacement of the alternator in a vehicle would also improve the available horsepower from the engine as traditional alternators use horsepower to operate.

A Tesla turbine of small size is placed in a housing with a generator. The structure of the Tesla turbine is a set of smooth discs with nozzles applying a moving gas to the edge of the disc. The gases drag on the disc by mean of viscosity and adhesion of the surface layer of the gas. As the gas slows and adds energy to the disks, it spirals into the centre and out the exhaust port. The nozzle input is attached to the exhaust of the engine to direct the gas toward the turbine. The nozzle inlet is designed to have a long tapering followed by a wide short taper. This venturi effect creates a high velocity flow with low pressure. The high velocity flow of the gas/fluid is desired to make the turbine spin faster.

The metal plates are connected to a shaft that rotates due to the action of gases on the discs. As the discs spin due to boundary layer effect the shaft also spins. The shaft is attached to a generator (which is part of the device). The generator then supplies power, providing an alternate power source to the alternator (potentially replacing the alternator) of a vehicle. This can offer a minor horsepower benefit as traditional alternators reduce horsepower output.

The device can replace a traditional muffler as Tesla boundary layer turbines in operation have the effect of reducing noise. In preliminary tests a prototype of the device has compared comparably in noise reduction to a standard automobile muffler.

Another possible embodiment of the invention is to connect to exhaust systems from industrial smoke stacks. The gas can be exhausted to create sufficient pressure through nozzle design. The exhaust feeds the Tesla turbine that can be mounted inside a stack and connected to a generator. The output of the generator can be feed back into the facility and used accordingly.

In another embodiment, the invention can be used for systems that output liquids under pressure. With sufficient velocity and pressure the turbine will spin and generate power.

The Tesla turbine is selected over traditional blade turbines due to its high efficiency under pressure and the ability to make it compact in size.

### DESCRIPTION OF DRAWINGS

FIG. 1 is top view with nozzle inlet for the gas/fluid

FIG. 2 is side view of the unit incorporating the turbine and generator

FIG. 3 is a side cross sectional view with cover removed showing shaft and overall turbine housing exhaust ports

FIG. 4 is view with exhaust diversion cover and outlet port

FIG. 5 is view of engine, catalytic converter and invention

FIG. 6 is air flow diagram illustrating the flow from inlet nozzle around plates to exhaust (Tesla turbine)

FIG. 7 is side view of individual plate and of internal nozzle design.

FIG. 8 is cross sectional view of the Tesla turbine with plates and shaft.

FIG. 9 is a diagram illustrating the potential of having multiple inlet nozzles.

FIG. 10 is a cross sectional diagram illustrating the discs on shaft and the generator connection.

FIG. 11 is a cross sectional of a means to mount and hole discs on the shaft.

### DETAILED EMBODIMENTS

As shown in the diagrams tor purposes of illustration, the present embodiment resides in a method for generating power from system exhaust.

The invention may be used as an option such as an after market conversion kit or in place of muffler on new vehicles. To be clear this device would replace a traditional muffler.

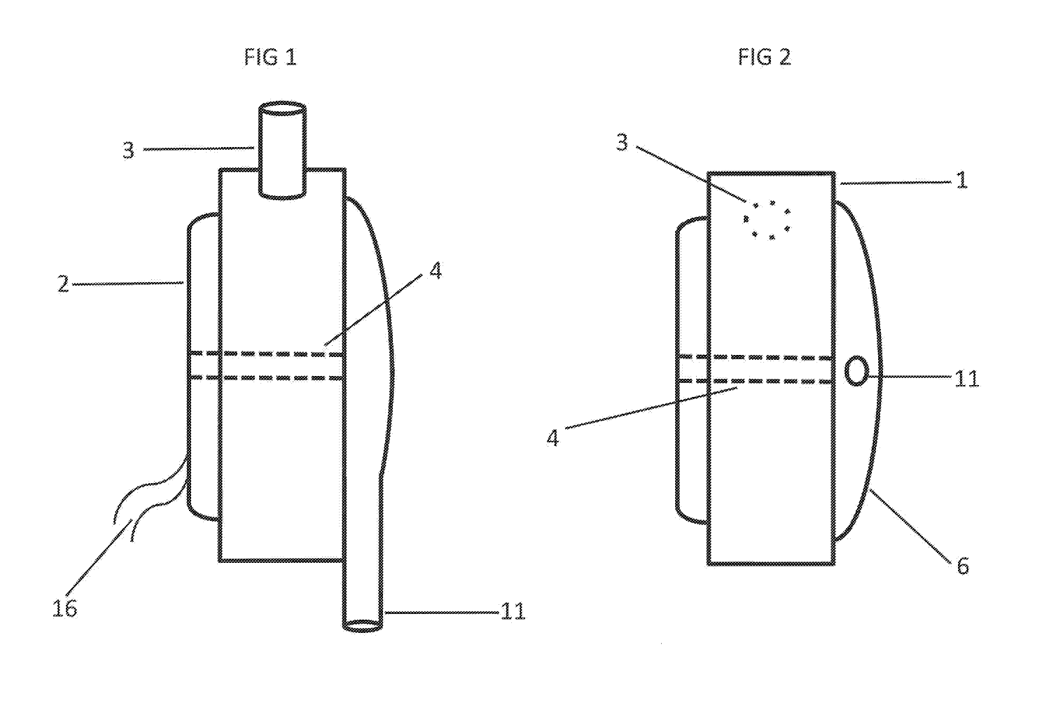

An embodiment of the invention is shown in FIG. 1 and FIG. 2, illustrating a housing 1 for the turbine with a flat pack generator 2 attached configured as a single unit. The invention has an inlet nozzle 3 and exhaust outlet port 11. The inlet nozzle and outlet port are designed to fit into standard automobile exhaust pipe. Leads 16 from the generator to battery or electrical system.

Gas/fluid enters the inlet 3 at preferably a tangential angle to the circumference of the blades 15 of the turbine. The boundary layer effect (through adhesion) uses the fluid/gas and causes the discs to spin. As the fluid/gas is pulled across the face of the disc the fluid/gas works it way to the exhaust holes. The gas/fluid flows through the holes to the exhaust port.

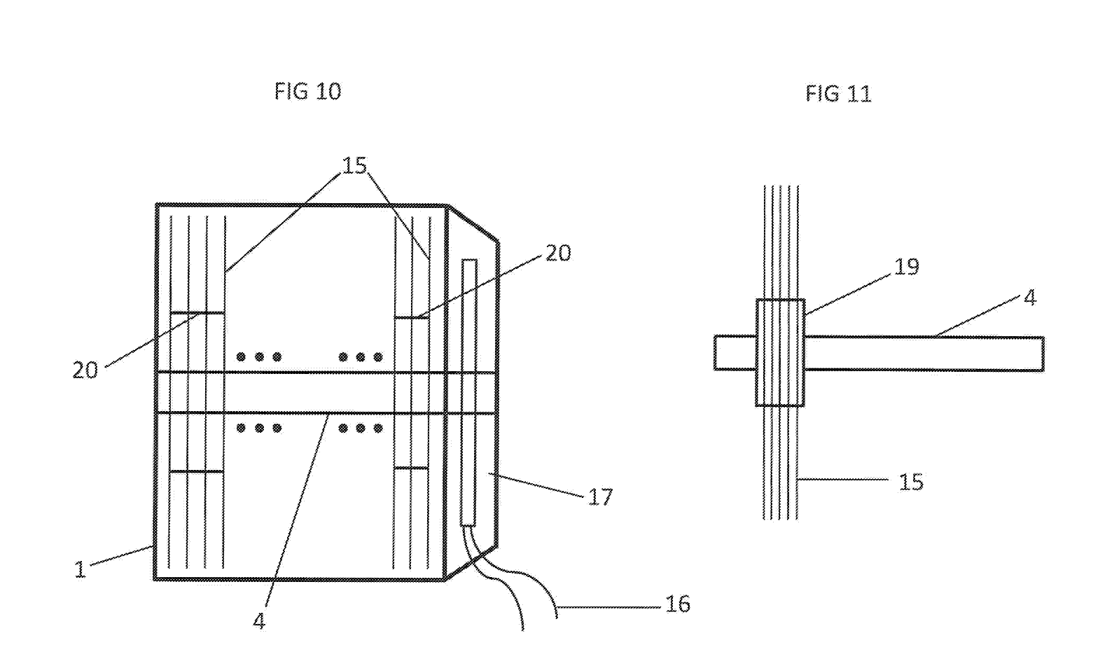

In FIG. 10, the discs 15 are mounted on the shaft 4 and spacers 20 are placed between them. The discs are held in place by compression on the shaft. In FIG. 11, the end discs are held in place to maintain the compression with a weld 19. When the discs spin the shaft also spins. Alternately, the discs could be individually attached to the shaft (eg. keyway, ringfitter, taperlock, weld etc.). The spinning shaft 4 provides motive power to attached generator 2. Alternately, the shaft could be connected to an alternator that would provide power to the charging system or battery.

The generator or alternator has two leads 16 that are the connectors. The generator or alternator leads connect to a charging system or battery. The alternator also has leads to a voltage regulator that controls the flow of energy.

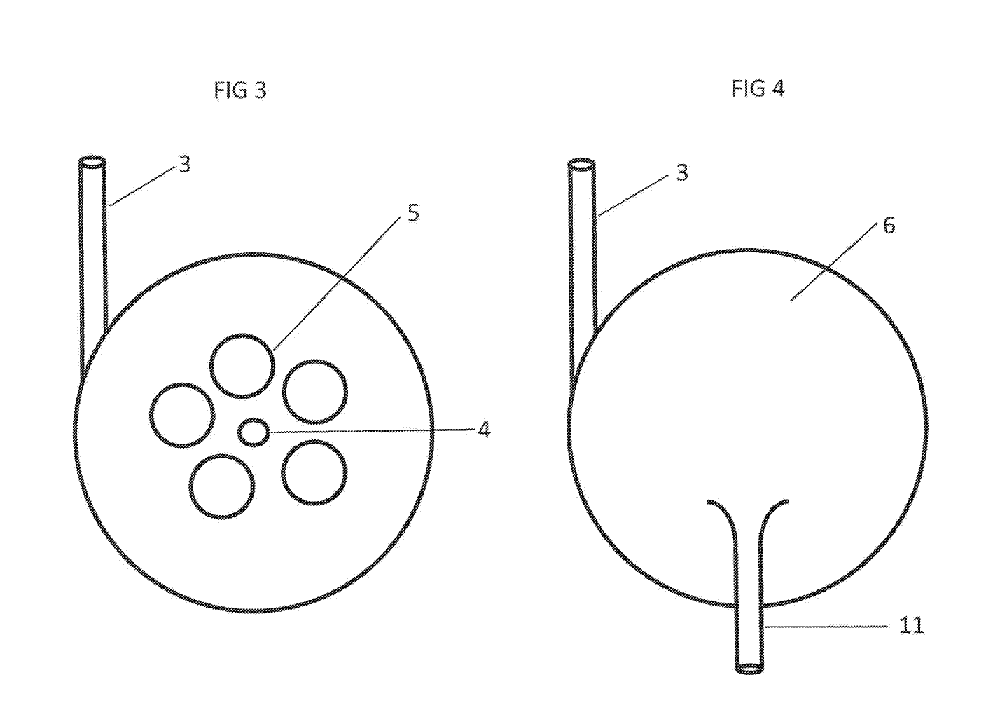

FIG. 3 illustrates a cross sectional view of the turbine housing with the exhaust diversion cover removed. The housing that holds the turbine has a set of exhaust ports 5. These ports take all the exhaust as it exits the turbine. The turbine does not modify the exhaust in anyway.

FIG. 4 shows the device with the exhaust diversion cover 8 placed to complete the unit. All the fluid/gas exhausts are directed to this single exhaust port 11.

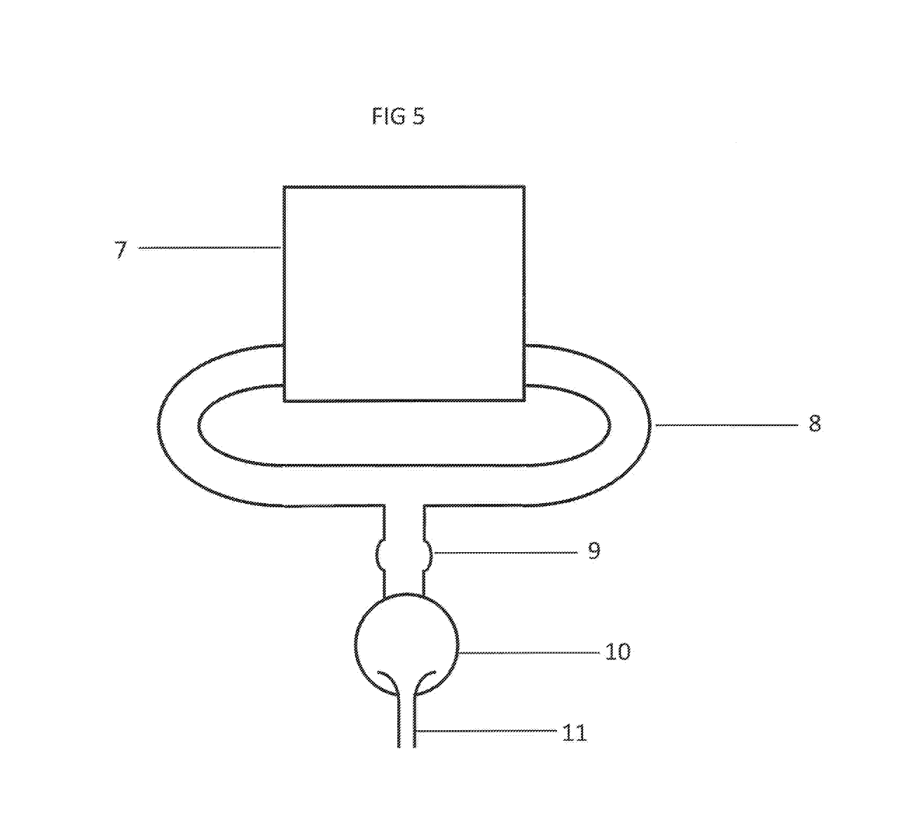

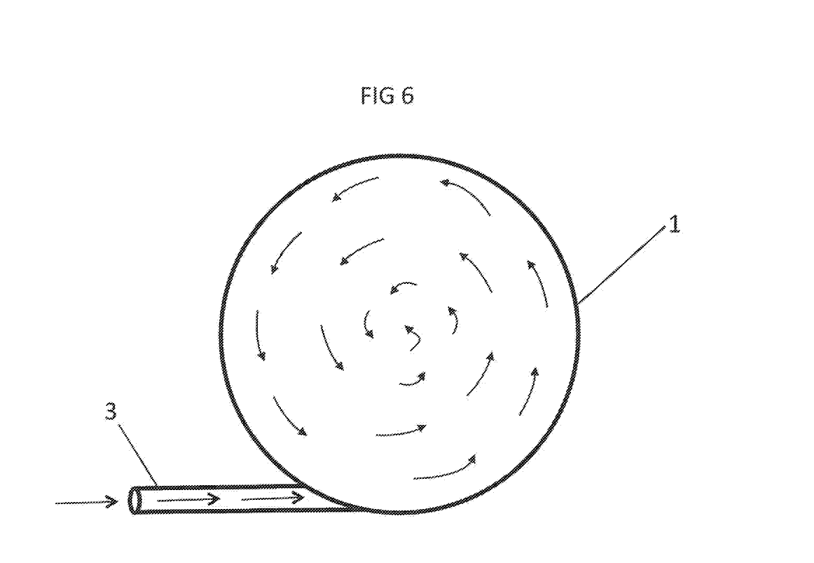

FIG. 5 consists of Infernal combustion engine 7. IC engines are designed such that fuel and air mix and are ignited. The gas created by this ignition Is forced out of the chamber by the piston and into the exhaust pipe 8. The exhaust travels through a catalytic converter 9 to remove harmful particulates and pollutants. The exhaust is then feed into the noise reducing power generation device 10.

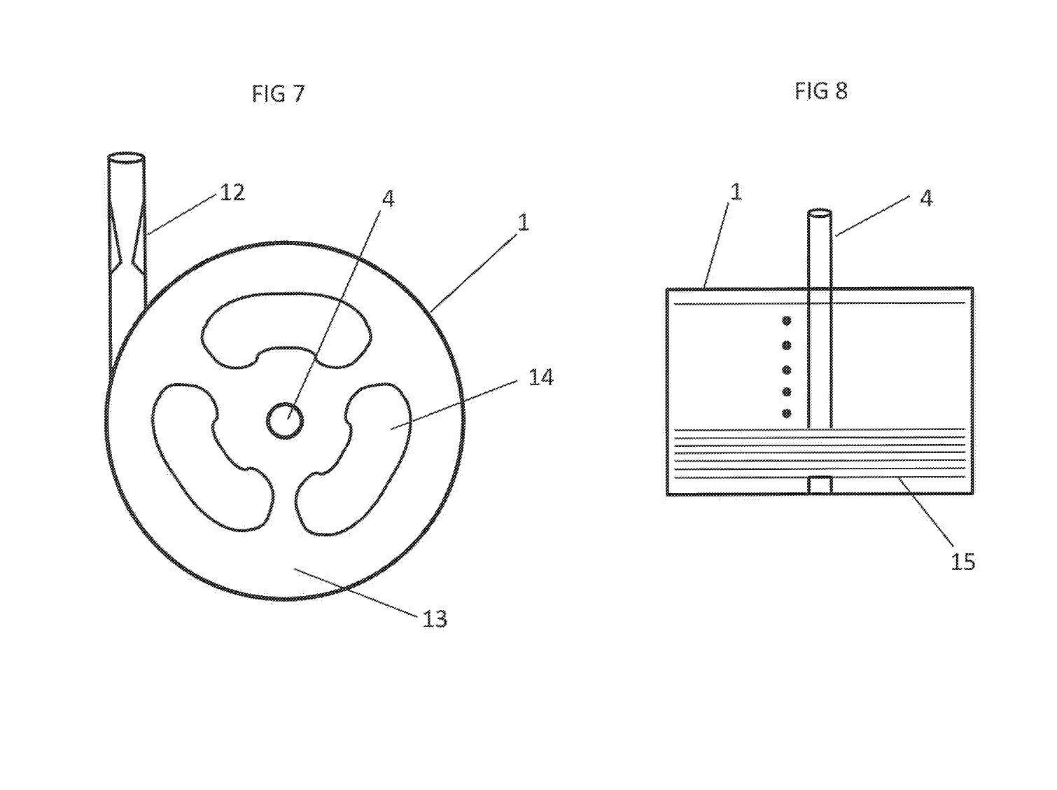

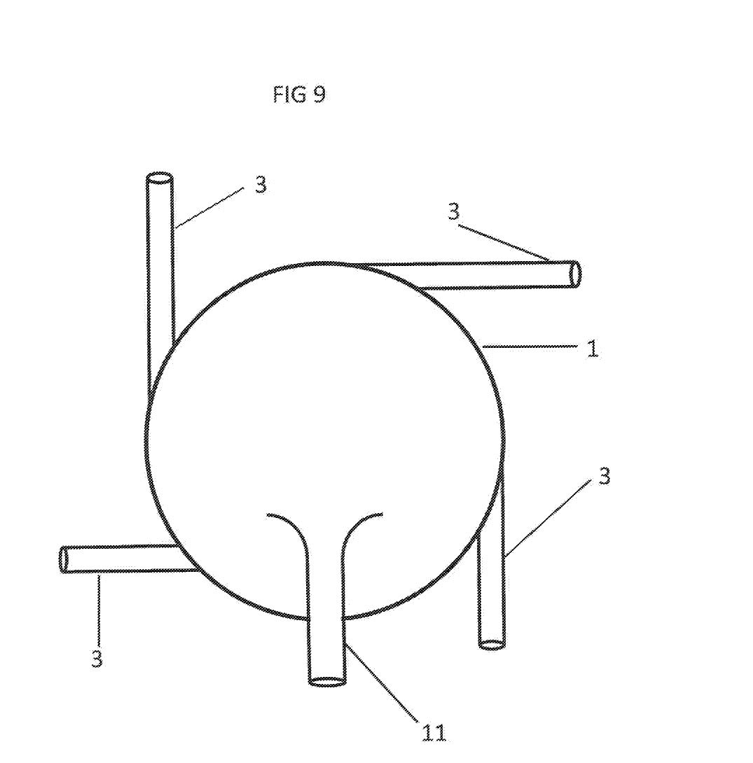

A Tesla turbine works on the principle of boundary layer effect. As the gas/fluid passes over the discs the boundary layer effect creates a spin of each individual disc 13 in FIG. 7. As the discs spin the gas/fluid passes over the discs toward the center as illustrated in FIG. 8 causing the shaft 4 to spin. Tesla turbines work in this mode and perform best when the gas/fluid enter at high velocity. To reach such velocity the gas/fluid typically needs to be under some pressure. In order to ensure that the backpressure of vehicle exhaust meets the need to spin the turbine the inlet nozzle 3 has an internal design 12 to create an increased velocity using the venture effect. Essentially the nozzle has a long taper to increase the pressure increasing the velocity of the gas/fluid. The short taper at the end is to allow the gas to rapidly expand without decreasing velocity substantially. This creates the effect of delivering more gas at higher velocity then a straight nozzle design. The desired effect Is to have the turbine spin faster increasing the overall efficiency and power output.

The Tesla turbine by nature of its construction and the gas flow acts as a noise-reducing device and thus can replace the muffler/baffles currently required on vehicles.

FIG. 7 illustrates a cross sectional view of a single disc. As per FIG. 8 Tesla turbines require multiple discs 15 to create the maximum rotation per minute. The individual discs in this embodiment have exhaust holes 14 of aoval based design. Exhaust holes on discs and of turbine housing can have different shapes. The drawings illustrate two possible examples but are not meant to be representative of all possibilities.

FIG. 9 shows another modification where multiple inlet nozzles can feed the device. Multiple inlet nozzles can create higher velocity and can reduce backpressure for the engine delivering the exhaust.

FIG. 10 is a cross sectional view of the generator 2 and its housing 18 mounted with the discs on the shaft. Leads exit the generator to battery or alternator (not shown) which could be incorporated as a component of the device.

FIG. 11 is a cross sectional view of the disc mounting on the shaft 4. Illustrated is one implementation where the end discs are welded 19 to the shaft to create a compression hold for the entire disc set 15 on the shaft. There are multiple mechanical means for holding the discs on the shaft.

What is claimed is:

1. A device for generating, electrical energy from exhaust gases comprising of:
(a) a housing having an inlet to accept said exhaust gases and an outlet to dissipate exhaust gases,
(b) a plurality of disks adapted for rotation about an axis of rotation when exhaust gases/fluid are directed over the disks,
(i) Presenting aligned exhaust holes directing exhaust gases/fluid to the said outlet,
(ii) presenting aligned exhaust holes for communicating with said outlet
(c) a generator coaxially associated with the said plurality of discs for generating electrical energy when the said disks rotate about the said axis.

2. A device as claimed in 1 wherein said discs define an annular periphery and said exhaust gases are directed over said annular periphery.

3. A device as claimed in 2 wherein said inlet is disposed tangentially relative to said annular periphery.

4. A device as claimed in 3 wherein said inlet includes a venturi design to obtain increased velocity at low pressure.

5. A device as claimed in 4 wherein said venturi design comprises a tapered restriction in said inlet.

6. A device as claimed in 5 wherein said exhaust holes are disposed equidistant about said axis of rotation.

7. A device as claimed in 6 connected to an internal combustion engine

8. A method for creating an energy source for a vehicle comprising of:
(a) Burning an air fuel mixture in an internal combustion engine of a vehicle
(b) Discharging burnt fuel air mixture through catalytic converter and pipes to a Tesla turbine which is connected to a generator

9. A method for creating energy from any system which exhausts gas/fluid that can be put under high velocity to spin a Tesla turbine of appropriate size
